(19) United States
(12) Patent Application Publication
(10) Pub. No.: US 2012/0283932 A1
(43) Pub. Date: Nov. 8, 2012

(54) TWO-STROKE INTERNAL COMBUSTION ENGINE WITH VARIABLE COMPRESSION RATIO AND AN EXHAUST PORT SHUTTER AND A METHOD OF OPERATING SUCH AN ENGINE

(75) Inventors: James William Griffith Turner, Wymondaham (GB); David Blundell, Dereham (GB)

(73) Assignee: LOTUS CARS LIMITED, Hethel, Norwich (GB)

(21) Appl. No.: 13/508,016

(22) PCT Filed: Nov. 4, 2010
(86) PCT No.: PCT/GB10/02036

§ 371 Date: Jul. 16, 2012

(30) Foreign Application Priority Data
Nov. 4, 2009 (GB) 0919330.1

(51) Int. Cl. F02B 75/04

(52) U.S. Cl. 701/103

(57) ABSTRACT

A two-stroke internal combustion engine for varying the compression ratio and the area of an exhaust port of a cylinder includes at least one piston reciprocable within a cylinder, an exhaust port opened and closed by the piston during the reciprocal motion thereof, moveable shutter means for varying the effective area of the exhaust port, a compression ratio variation mechanism for varying a compression ratio of the cylinder, sensor means for measuring one or more operating characteristics of the engine and for generating signals corresponding thereto, and a control unit which processes the signals generated by the sensor means and controls the motion of the shutter means accordingly and controls the compression ratio variation mechanism to vary the compression ratio of the cylinder; wherein the engine can operate with a compression ratio in the range 30:1 to 50:1.

The invention relates to a two-stroke internal combustion engine and more particularly to an arrangement for varying the compression ratio of such and the area of an exhaust port of a cylinder of such.

In a ported two-stroke engine the skirt of the piston serves to close the ports in the cylinder, one or more of these ports serving to provide a passage for the injection of a fresh charge of air or a fuel/air mixture to the cylinder and one or more other ports serving to provide an exhaust output for the combusted gases. The inlet ports and exhaust ports are arranged in the cylinder so that on downward movement of the piston the exhaust ports are uncovered first, the high pressure differential between the gases in the cylinder and atmospheric pressure causing the combusted gases to flow out of the cylinder into an exhaust passage which leads to an exhaust pipe which delivers the gases to the atmosphere. On further downward motion of the piston the inlet ports are uncovered enabling a fresh charge of pressurised fuel/air mixture to be delivered to the cylinder for combustion. The pressurised delivery of gas also serves to force combusted gases from the cylinder, a process known as scavenging.

In traditional loop-scavenged two-stroke engines, the time during which both the inlet and the outlet ports are uncovered is controlled solely by the motion of the actual piston itself, the only means of closing the apertures being provided by the piston. When the piston moves towards the top of the cylinder it closes first the inlet ports and secondly the exhaust ports.

In EP-0526538 there is described a two-stroke engine comprising a moveable shutter for varying the effective area of the exhaust port. The shutter varies the effective area cyclically in a timed relationship to the reciprocal motion of the piston within the cylinder. Sensors measure operating characteristics of the engine and a control unit processes signals generated by the sensors and controls the motion of the shutter accordingly. The shutter is operated by a transmission mechanism which oscillates the shutter between a first position in which the exhaust port has a first effective area and a second position in which the exhaust port has a second smaller effective area. The transmission mechanism is connected to a crankshaft connected to the piston of the engine and comprises a plurality of interconnected links. The shutter is in or close to the second position thereof when the piston passes the shutter when moving from the bottom dead centre position thereof to the top dead centre position thereof. The first position of the shutter is varied by the control unit with changes in sensed operating characteristics of the engine. The shutter is in or close to the first position when the piston passes the shutter when moving from the top dead centre position thereof to the bottom dead centre position thereof. The control unit varies the first position of the shutter with change in sensed operating characteristics to advance or retard the opening of the exhaust passage. The control unit varies the first position of the shutter by varying the amplitude of oscillation of shutter travel between the first and second positions thereof. The control unit decreases the shutter movement to retard opening of the exhaust passage. The second position of the shutter is constant for all engine operating conditions. An electro-mechanical device is connected to one of the interconnected links, the electro-mechanical device being controlled by the control unit to alter the configuration of the interconnected links to vary the cyclical motion of the shutter.

The “effective area” of the exhaust port is the area through which gases may pass to the exhaust passage. The exhaust port itself will have a fixed area, being an aperture machined in the side of the engine's cylinder. The shutter acts to vary the effective area of the exhaust port.

The engine of EP0526538 enables the point at which the combined gases can flow from the cylinder in each cycle to be varied with varying engine characteristics by alteration of the first position of the shutter, (i.e. the position in which the exhaust port has the largest effective area).

Recently to achieve cleaner combustion, engines have been run with Homogeneous Charge Compression Ignition (HCCI). This involves introducing gasoline into a mixture of charge air and combusted gases and then allowing the formation of a roughly homogeneous mixture which ignites on compression (without a spark). The combustion process requires retention of heat and/or combusted gases in a cylinder.

In EP 0526538 concern was expressed about the retention of combusted gases as a result of the use of the shutter; this was felt undesirable.

In GB2438206 there is described a two-stroke internal combustion engine comprising: at least one piston reciprocable within a cylinder; an exhaust port allowing communication of the cylinder with an exhaust passage, which port is opened and closed by the piston during the reciprocal motion thereof, moveable shutter means for varying the effective area of the exhaust port, which shutter means varies the effective area cyclically in a timed relationship to the reciprocal motion of the piston within the cylinder; a compression ratio variation mechanism for varying a compression ratio of the cylinder, sensor means for measuring one or more operating characteristics of the engine and for generating signals corresponding thereto; and a control unit which processes the signals generated by the sensor means and controls the motion of the shutter means accordingly and controls the compression ratio variation mechanism to vary the compression ratio of the cylinder.

The engine of GB2438206 enabled HCCI combustion over a large area of an engine operating map (idle, low, medium loads and preferably medium high loads and towards higher speeds), hence enjoying simultaneous emission reduction (NOx and HC) and improved fuel efficiency compared with the four-stroke gasoline equivalent.

In a four-stroke gasoline engine (PFI or GDI) the HCCI operating range is limited to low to medium loads and speeds approaching 4000 rpm, since at idle there is not enough heat to initiate and sustain complete HCCI combustion whilst at high loads the rate of heat release (combustion speed) is too high and can damage the engine. In gasoline applications the trapped exhaust gas is an initiator to the HCCI, which is in contrast to its use in the diesel application where it is used as an inhibitor to the HCCI process. Therefore, in order to maintain the temperatures required for gasoline HCCI the exhaust gas needs to be trapped internally which requires variable valve timing. The minimum requirement for a four-stroke gasoline engine would be cam profile switching with twin cam phasers. However, fully variable valve events would be better. There is no doubt that HCCI combustion can drastically reduce NOx, however the operating range of the engine for such a reduction is quite small and is much less than the operating range of the auto ignition itself. HCCI also has the potential to reduce fuel consumption. The end-of-compression temperature governs the combustion process and hence the heat of the trapped exhaust gas influences this. At light load, it is possible to use a significantly higher quantity of exhaust gas without detonation/excessive combustion rate issues as the temperature of the gas is lower due to the lower fuel requirement. At higher loads, the exhaust gas quantity has to be reduced, as the heat content is higher. The use of variable compression ratio (CR) gives a second controlling option for end-of-compression temperature allowing better optimisation of exhaust gas quantity in order to minimise NOx and widen the auto ignition operating range. The design and implementation of variable CR is, however, technically difficult in a four-stroke engine and inevitably leads to increased engine costs.

In a two-stroke gasoline engine the HCCI operating range is larger due to the nature of the two-stroke cycle itself i.e. its reduced cycle time and quantity of residual exhaust gas. Although two-stroke gasoline engines have demonstrated HCCI at idle, the methods used for this are not feasible for the total operating range of the engine. A higher compression ratio could make this possible whilst using a lower compression ratio would extend the upper HCCI operating range. In a first commercial application, which is likely a ‘hybrid’ HCCI-SI engine, two-stroke operation provides easier switching between operating modes of HCCI and SI (Spark Ignition) compared to a four-stroke, due to its gas exchange process.

It is also worth mentioning that the pumping work of the two-stroke is lowest at light load and increases (although it is not as bad as a four-stroke engine) as the load increases thus suiting the real world operation of the vehicle better than a four-stroke engine. In this case, stratified charging/combustion can be utilised if desired rather than required.

The move towards gasoline direct ignition (GDI) eases the introduction of the two-stroke engine, as this technology would be mandatory to achieve emission/fuel consumption legislation. HCCI was first discovered on the two-stroke engine and has been found to have a wider operating range there than in the four-stroke engine.

The simple combustion chamber of a ported two-stroke engine allows easy variation of CR through the application of a junk ringed head (similar to an upside down piston). The application of this makes two way catalytic conversion a real possibility as NOx generation using auto ignition should be very low. The variable CR has no negative impact on intake pumping work on the two-stroke, unlike the four-stroke in which the pumping work increases with increasing CR.

The shutter varies the angle-area of the exhaust port aperture and hence can be used to keep the time-area requirements appropriate throughout the speed range of the engine. If the shutter is also varied at constant (or varying) speed whilst changing load condition, then varying the exhaust port aperture will influence the scavenging efficiency to effectively give control of the mass of trapped exhaust residuals. This will influence the initiation/control of HCCI. A secondary control system which further improves HCCI operation is provided by a wide varied range of CR. This offers significant variation to end of compression charge temperature, allowing this to be increased at light load to lower the operating range to possibly include idle. When the combustion becomes too strong at higher speeds/loads, the variable CR mechanism allows a wider and more optimised range of HCCI operation with less compromise to the operating cycle and the gas exchange process.

The present invention provides a two-stroke internal combustion engine as claimed in claim 1 and a method of operating a two-stroke internal combustion engine as claimed in claim 15.

Since developing the engine of GB2438206, the applicant has made some surprising discoveries. First of all the arrangement of a compression ratio variation mechanism for varying a compression ratio of the cylinder and shutter means enables the engine to run satisfactorily with highly unusual compression ratios of 30:1 to 40:1 at idle, above 40:1 on starting or above 50:1 on starting with ambient air temperatures below −30° C. and higher, outside the normal operating range of a gasoline engine. Previously 21:1 was the highest known compression ratio used for HCCI in a gasoline engine, and then with intake air heating still being necessary. A compression ratio of 27:1 was known for HCCI in an engine using methanol. A compression ratio of 10:1 to 12:1 is typical in a conventional two-stroke engine.

Not only does this development of the engine of GB2438206 enable surprisingly good and stable HCCI operation of the engine at idle, it even enables the engine to be started in HCCI operation mode, even when cold. This enables the engine to dispense with the need for a spark plug. This means also that the cylinder head design can be greatly simplified, since there is no need to accommodate a spark plug or to compromise the combustion chamber design to allow for spark ignition combustion. For instance a moving puck could be provided equal in diameter to the cylinder and this large diameter puck could be moved mechanically, electronically or hydraulically by a system which uses pressurised engine oil, or by a combination of these mechanisms.

The engine run at very high compression ratios has been found to give minimal NOx emissions—down to background levels at idle. Even at higher loads the NOx emissions are low double-digit parts per million up to 2000 rpm, 3 bar IMEP (e.g. approximately 20 ppm at 2.3 bar IMEP (2-stroke)). HC and CO emissions of the 2-stroke engine are comparable to similar 4-stroke engines. The high compression ratio gives rise to significant compression heating which forces the reactions of HC to HCO to CO to CO₂ to completion. It has also been found that use of E85 instead of gasoline gives slightly better NOx output that gasoline and that use of diesel gives slightly higher NOx and HC emissions similar to gasoline.

With the engine of the present invention it may be possible for the engine to dispense with NOx aftertreatments and with fuel consumption better than for a spray-guided engine.

The ability to operate HCCI from a cold start can significantly reduce cold start emissions and thus loading of the oxidising catalyst.

With the concept ‘upsizing’ may be the best way to improved fuel economy and reduced powertrain cost, since such an engine with its reduced need for aftertreatments will be cheaper to produce than a turbo-charged direct injection spark ignition 4-stroke engine (the currently preferred approach).

The current trend with four stroke engines is to ‘downsize’ (reduce engine capacity) in order to reduce the pumping work of the engine for engine operations which occur during running of engine in tests which determine if the engine meets emissions regulations (‘the legislative cycle’).

Pumping work is defined as the work done during the gas exchange process and hence is the work done to expel the exhaust gas during the exhaust stroke and to draw in the fresh air/charge during the intake stroke. At low operating loads, as would typically be seen in the drive cycle, the throttle is virtually shut and hence the high expansion ratio of the piston moving down the cylinder creates very low pressure in the cylinder resulting in high intake pumping work in a four-stroke engine. Any further opening of the throttle increases the pressure in the cylinder thus reducing the intake pumping work and hence the level of total engine friction. In this respect, it can be seen that for a four-stroke engine intake pumping work is highest (relative to the power produced) at closed throttle, gradually reducing as the throttle is opened. Increasing compression ratio increases the expansion during intake to further increase pumping work in the four-stroke. With regards to exhaust pumping, the quantity of exhaust gas being pumped out of the cylinder increases with increasing load and so is in conflict with the intake strategy. However, the exhaust pumping work is significantly lower than the intake at the part load conditions and so a net improvement is recognised as a result of the reduced level of total engine friction. As a result, downsizing the engine means the throttle has to be opened further to achieve the same power as a larger engine and hence pumping work is reduced.

Pumping losses in a two-stroke engine are quite different to those of a four-stroke engine. Airflow into the two-stroke engine begins (primary pumping) with air being drawn into the crankcase or through the blower in the case where external scavenging is employed. In either case, the expansion of both systems is low resulting in a minimal pressure drop across the throttle at all operating speed and load conditions. From here, the charge enters the cylinder via transfer ports thereby increasing secondary pumping effort as more charge is required for higher loads. This is the exact opposite of what happens in the four-stroke engine lending the two-stroke more suitable operating characteristics for real world operation. There is in effect no exhaust pumping work as the majority of the exhaust self evacuates during blowdown. The residual exhaust loss occurs during scavenging and is therefore included in the secondary pumping work through the transfer ports. Compression ratio in the cylinder has no effect on pumping work in the two-stroke.

The rationale for downsizing to improve fuel economy by reducing pumping in a four-stroke engine would not be the same for the two-stroke. The possible advantage of downsizing a two-stroke would be to increase the operating load to a more fuel efficient region. However, from a NOx viewpoint, upsizing the two-stroke engine (increasing the capacity) would be very beneficial. Power is the rate of doing work and as a two-stroke fires twice as often as a four-stroke engine, then its rate of doing work is twice that of the four-stroke. So, a four-stroke engine of the same size and speed as a two-stroke would have to run at twice the load to make the same power. If the capacity of the four-stroke is doubled, maintaining the same speed, it will make the same power at the same load as the smaller two-stroke but then the pumping losses would be exacerbated by the increased capacity, as described above, therefore worsening the fuel consumption. If the capacity of the two-stroke engine is doubled over the four-stroke, then the load would be VI of the half sized four-stroke for the same power due to the doubled firing frequency and the doubled capacity.

In tests, the applicant has achieved very low NOx (20 ppm) at 2.3bar IMEP (indicated mean effective pressure) with an engine according to the present invention. This load would be 4.6bar for an equivalent sized four-stroke engine and represents about 40% of full load operation. Taking a 1.61 tr two-stroke engine as a typical example, if the capacity is increased by the ratio of 100/40, this would give 41 trs and result in a significant upsizing. However, the engine out NOx would be 20 ppm with the same full load/power achieved by the 1.61 tr two-stroke. No NOx catalysation would be required, not just for the legislative cycle, but for the whole operating range of the engine.

As a result, upsizing the two-stroke engine offers the possibility of achieving legislative NOx whilst using a two way catalyst for HC and CO. Although the fuel consumption would be slightly worse at the very light loads (compared to itself) the engine according to the present invention demonstrated extremely low fuel economy down to no load operation bettering the best homogeneous GDI four-stroke engines at their best operating region. Upsizing the engine of the present invention also improves low load throttle response and allows lower gear ratios which improves fuel economy further.

The engine of the current invention will idle in full HCCI operation at speeds of revolution less than 450. This is unheard of before. The engine operated from start with HCCI and so no spark ignition system is needed. The low emission characteristics of the engine are thus available from a cold start. The best efficiencies are seen with higher octane fuels.

Preferred embodiments of the present invention will now be described with reference to the accompanying drawings, in which:

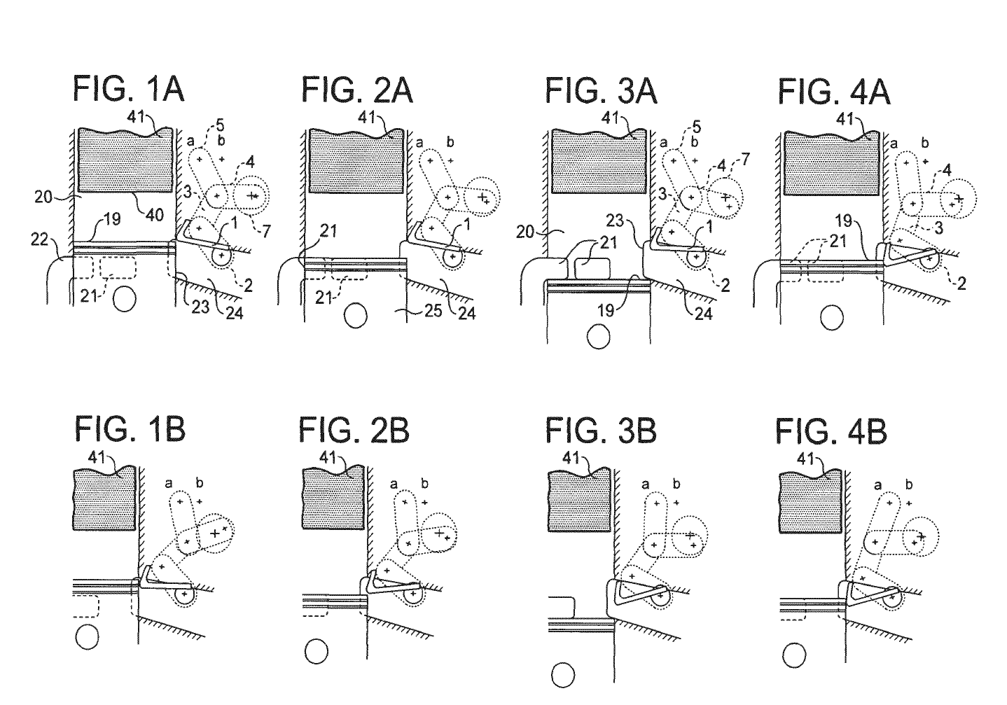

FIGS. 1A to 4A are simplified diagrammatic cross-sections of a piston and cylinder arrangement according to the invention showing the arrangement at different stages during the cycle;

FIG. 1B to 4B are simplified diagrammatic cross-sections of a piston and cylinder arrangement according to the invention showing the same sequence as FIGS. 1A to 4A but with the arrangement adjusted to account for a change in an operating characteristic of the engine;

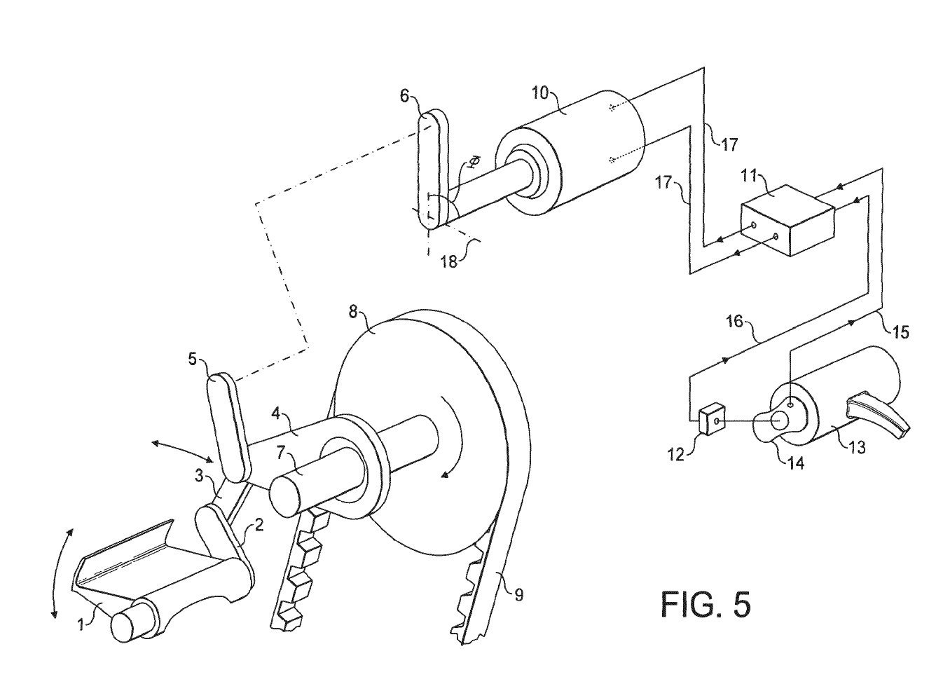

FIG. 5 is a schematic representation of one embodiment of the invention;

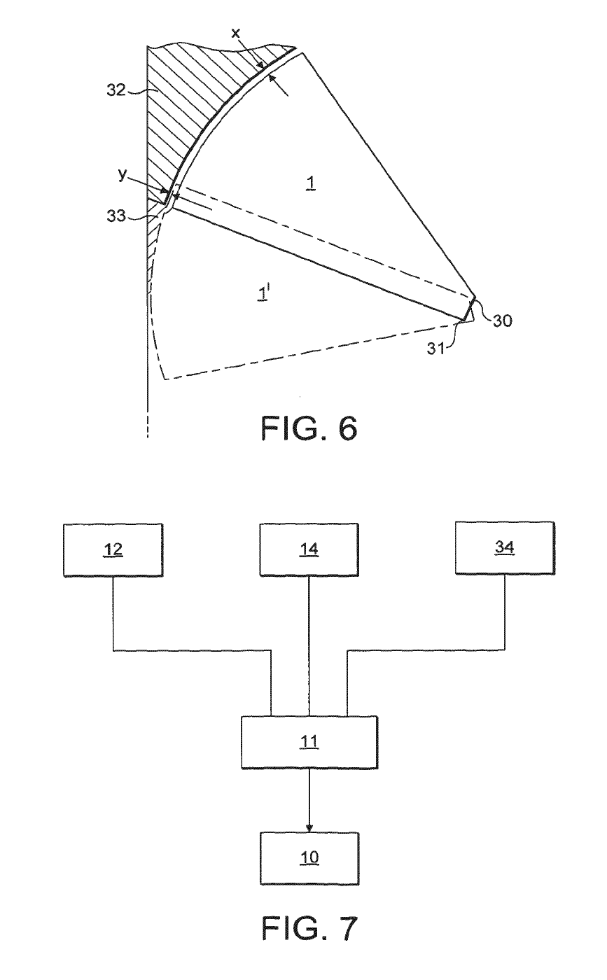

FIG. 6 shows a detail of a preferred embodiment of the invention; and

FIG. 7 shows a typical control scheme for an embodiment of the invention.

FIGS. 1A to 4A show a high speed/high load operation condition of the engine. FIG. 1A shows a piston 19, a cylinder 20, a plurality of inlet ports 21, inlet passage 22, an exhaust port 23 and an exhaust passage 24. Operable in the exhaust passage to vary the effective area of the exhaust port 23 is a shutter 1, operated by a mechanism including first link 2, second link 3, third link 4, fourth link 5 and crankshaft 7. The fourth link 5 is connected to a servo motor (not shown in FIG. 1, but shown in FIG. 5 and described later in the specification) by fifth link 6. The piston 19 is connected via a conventional gudgeon pin and connecting rod (not shown) to an output crankshaft (not shown). The output crankshaft is connected by the pulley belt to the crankshaft 7.

The cylinder 20 is defined in part by a movable end surface 40 provided by a ringed junk head 41, or puck, slidable axially along the cylinder 20. The junk head 41 is movable to vary the compression ratio in the cylinder 20. Piston rings (not shown) provide a seal between the junk head 41 and the surrounding cylinder 20; two piston rings could be used, but to allow for high compression ratios three or more may be preferable, to minimise leakage past the puck. The ‘puck’ diameter is Ø58 mm and it is water-cooled. Its area is 45.5% of the bore area and has a 15.85 mm total stroke. Since the cylinder head does not have poppet valves an extremely high compression ratio variation is possible, e.g. from 10:1 to 40:1.

FIG. 1A shows the piston 19 at a point when the piston and piston skirt 25 just covers the exhaust port 23. Typically this occurs when the output crankshaft has rotated 85° from top dead centre. The piston skirt 25 covers completely the inlet ports 21. The shutter 1 is withdrawn into the wall of exhaust passage 24. The gases in the cylinder in FIG. 1 have been combusted.

FIG. 2A shows the piston 19 at a point when it has moved downwards from its position in FIG. 1A, on rotation by roughly 28° of the output crankshaft. Since the crankshaft 7 is connected to the output crankshaft, the crankshaft 7 has rotated a corresponding degree, causing corresponding motion of the four links 2 to 5. The motion is not however sufficient to cause the shutter 1 to enter the exhaust port 24. The exhaust port 23 has been uncovered by the piston 19 and hence the combusted gases present in the cylinder at high pressure flow out of the cylinder through the exhaust port 23.

FIG. 3A shows the piston when it has moved downward from its position in FIG. 3A to bottom dead centre. The piston 19 has uncovered the inlet ports 21 and pressurised fuel/air mixture can enter the cylinder 20 through the inlet ports 21. The pressurised fuel/air mixture drives remaining combusted gases from the cylinder into the exhaust passage 24. The pressurised fuel/air mixture drives remaining combusted gases from the cylinder into the exhaust passage 24. However, excessive loss of fuel/air mixture is prevented by the reduction of the effective area of the exhaust port 23 by the shutter 1. The reduction in the effective area of the exhaust port occurs since movement of the output crankshaft with the downward motion of the piston 19 between FIG. 3A and 4A has caused the crankshaft 7 to move by the previously mentioned pulley and belt means. The movement of the crankshaft 7 causes motion of the links 2,3 and 4 in such a way that the shutter 1 is pivoted into the exhaust passage 24, reducing the effective area of the exhaust port 23.

In FIG. 4A the piston 19 has begun its upward motion and the piston skirt 25 has closed the inlet port 21. Typically this would occur after the output crankshaft has rotated 247° from Top Dead Centre. The motion of the piston between FIG. 3A and FIG. 4A causes a rotation of the output crankshaft which results in a corresponding rotation of the crankshaft 7. The rotation of the crankshaft 7 via the link members 2, 3 and 4 causes the shutter 1 to rotate from the position shown in FIG. 4A and further decrease the effective area of exhaust port 23. The reduction in effective area of the exhaust port 23 by the shutter 1 enables the piston 19 to close the port 23 at an earlier stage in its upward motion than would have otherwise been possible. The earlier closure of the port enables a longer period of compression of the fuel/air mixture, allowing a higher peak pressure to be achieved and greater engine thermal efficiency.

In all of FIGS. 1A to 4A, the junk head is retained in an uppermost position in which the compression ratio in the engine is at a minimum.

FIGS. 1B to 4B show a low speed/low load operating condition of the engine. FIG. 1B shows the piston in the same position relative to the cylinder as 1A. The junk head 41 has been lowered to its lowermost position to increase the compression ratio in the cylinder 20 to its maximum. Also the shutter position in FIG. 1B does not correspond to that of FIG. 1A. The control system has acted to take account of engine load and engine speed and has caused the servo-motor to rotate the fifth link arm 6 such that the configuration of the four link arms 2 to 5 is adjusted. The adjustment of the geometrical arrangement of the four link arms 2 to 5 from that of FIG. 1A to that of FIG. 1B reduces the extent of shutter travel. The geometry of the arrangement is such that the maximum reduction of area of the exhaust port 23 by the shutter 1 is the same for all positions of the controlling fifth link 6. However, when the fourth link 5 is in the position shown in FIGS. 1B to 4B the shutter is never fully retracted into the wall of the exhaust passage as shown in FIG. 1A. The decreased shutter travel of FIGS. 1B to 4B allows less fuel/air mixture to be exhausted without combustion than the full shutter travel of FIGS. 1A to 4A. It also allows the time for which the interior of the cylinder is open to the atmosphere to be reduced when compared with both a normal two-stroke engine and also when compared with the arrangement of FIGS. 1A to 5A. This enables retention of combusted gases in the cylinder 10 to facilitate HCCI. Whilst above the linkage is arranged to keep the maximum reduction of area constant, the lowermost shutter position could be varied in some embodiments in direct relationship to the extent of shutter travel, which may be desired in lower specific output engines running HCCI.

In a preferred embodiment of the present invention the level of lowest part of the shutter 1 when at its lowest level corresponds to a point below the highest point of the inlet apertures 21. The shutter is at its lowest position just after the piston fully closes the inlet apertures 21 on its upstroke. However, the exhaust passage is opened to the cylinder before the piston uncovers the inlet apertures on its downstroke. This allows exhaustion of combusted gases before the fresh charge of fuel/air mixture is delivered.

Therefore, the timing of the opening and closing of the exhaust port is “asymmetric” with respect to piston position. The exhaust port is opened when the piston is at a higher position with respect to the cylinder in its downstroke than the position of the piston when the exhaust port is closed in its upstroke. The system allows asymmetric timing of the movement of the shutter with respect to the position of the piston, and varies the asymmetry in accordance with varying engine parameters such as load, speed and temperature.

The configuration of FIGS. 1A to 4A is designed for high speeds and/or high loads. The time available for exhaustion of combusted gases is less than at low speeds and hence the shutter should be retracted fully so as not to hinder the exhaust process. At part-load and low load operations, the engine is operated using HCCI combustion by raising the compression ratio to levels not previously known for this purpose, as will be described below. The raising of the compression ratio enables this by raising the compression end temperature. This is also helped by trapping exhaust gases in the cylinder for mixing with the fresh charge air. The partially closed shutter acts to prevent all the combusted gases being exhausted, to effectively “trap” combusted gases in the cylinder for mixing with the charge air and fuel next delivered. The arrangement of FIGS. 1B to 4B also increases the torque provided by the engine at low speeds since the opening of the exhaust passage to the cylinder is delayed and hence the period during which the expanding combusted gases act on the piston increased. Also the compression ratio is increased by moving the junk head 41 to achieve a higher end of combustion temperature.

FIG. 5 shows the shutter 1, the first link 2, the second link 3, the third link 4, the fourth link 5, the fifth link 6, a crankshaft 7 (the link 4 has an aperture in which rotates an eccentric which rotates with the shaft 7) a pulley 8, a belt 9 driven from the engine output crankshaft (not shown), a servo-motor 10, a control unit 11, sensors 12 and 14 and an inlet manifold 13. An electrical sensor 14 is disposed in the inlet manifold to measure the gas pressure therein. The sensor sends a signal via a line 15 to the control unit 11. An engine speed sensor 12 measures the rotational speed of the engine in which the arrangement is present. The engine speed sensor 12 sends a signal to the control signal 11 via a line 16. The control unit 11 comprises electronic circuiting which compares and combines the signals it receives in accordance with pre-programmed instructions. The control unit 11 sends an instruction signal to servo-motor 10 via lines 17. The signal instructs the servo-motor to rotate the fifth link 6 to a required angle Φ with regard to an arbitrary fixed reference 18.

The electronic control unit determines, according to pre-programmed instructions, the best combination of compression ratios and effective port area for all speeds and loads.

At low engine speeds the decreased shutter movement allows the pressure on the piston due to expansion of the combusted gases to provide power for a greater fraction of the engine cycle by the partial closure of the exhaust port on the downward motion of the piston. The instant in the cycle at which the exhaust port is open to the interior of the cylinder can be delayed for up to approximately 14° rotation of the output crankshaft as compared with an arrangement without a shutter. This allows the retention of exhaust gases for mixing with the fresh charge of fuel/air mixture and thus permits HCCI operation. It may be desired to delay the opening of exhaust port by more than 14° of output crankshaft rotation for HCCI operation.

A control schematic for the control unit 11 is shown in FIG. 7. In a preferred embodiment the control system of the invention incorporates three sensors 12, 14 and 34. The sensor 12 measures engine speed typically by measuring the speed of rotation of the crankshaft rotated by the working pistons of the engine. The sensor 14 measures engine load for instance by measuring the pressure of gases in the inlet manifold (as shown in FIG. 1) or by an airflow meter monitoring flow of gases into the cylinder. The sensor 34 measures the temperature of the coolant of the engine and measures ambient air temperature.

The control unit 11 controls the servo-motor 10 to vary the point at which the shutter opens the exhaust passage to the working cylinder. The exhaust passage opening point is calculated in terms of degrees before piston bottom dead centre (or degrees after top dead centre) and is approximately proportional to the sensed engine speed, with maximum engine speed requiring maximum travel of the shutter 1 and maximum opening time for the exhaust aperture. The control unit 11 also controls an actuator (e.g. a hydraulic actuator) which is not shown in the drawings, to move the junk head to vary the compression ratio in the cylinder having regard to engine speed and/or load.

Whilst the preferred embodiments described above uses a servo-motor to rotate the link 6, any electro-mechanical device could be used that could rotate the link 6 in the required manner. For instance, a hydraulic actuator could be used, the piston of such actuator being connected to a link pivoted roughly halfway along its length, movement of the piston causing the link to rotate about its pivotal axis.

To obtain the full advantage of the invention disclosed herein, the shutter should be formed so that the shape of its lower edge conforms as closely as possible to the shape of the top of the exhaust passage, such that when the shutter is retracted and the exhaust apertures initially opened in the high speed operation mode, the gas velocity being at its highest, there is a minimum of disturbance of the flow passing through the exhaust passage. This way, the performance of the engine is not detrimentally affected by obstruction of the flow of the combusted gases through the exhaust passage.

A detail of the shutter arrangement can be seen in FIG. 6. In FIG. 6 the shutter is mounted such that it pivots about the point 30, which is eccentric of the point 31 on the lowermost edge of the shutter 1. The shutter 1 can be seen in its retracted position within the recess in the exhaust passage and also at 1′ in a second position reducing the area of the exhaust port. The clearance between the shutter and the housing 32 is reduced as the shutter reaches its lowermost point due to the offset. This can be seen at X and Y in the FIG. 6, X showing the clearance that would prevail without offset and Y showing the clearance that prevails with offset. This has the advantage of reducing the volume 33 formed between the piston and the shutter which is a source of hydrocarbon emissions through the exhaust passage and a loss of power. It also has the advantage of reducing the leakage path between the shutter and the working piston.

Whilst above variation of compression ratio is achieved by the movement of a ringed junk head in a cylinder, other methods of varying compression ratio could be used instead (e.g. by having a piston of variable length or a cylinder block pivotable about an axis to vary the uppermost limit of piston motion in each stroke).

Whilst above the shutter mechanism is described and illustrated (in FIG. 5) having a crankshaft 7 driven by a pulley 9, the crankshaft 8 and pulley 9 could be omitted if the main crankshaft of the engine is provided with an eccentric drive driving the mechanism.

Essential to HHCI operation at idle and cold start (or any operating speed load condition) is sufficient temperature towards the end of the compression stroke to ignite the charge.

The usual method in a fixed compression ratio engine is to trap exhaust gas from the previous cycle and use the heat energy from this and the ensuing compression stroke, to raise the temperature sufficiently for auto-ignition. For a fixed speed/load condition, trapping more exhaust gas will raise the temperature and advance the combustion whilst less exhaust gas trapped will have the reverse effect. The reducing fuel content with lower load operation means there is less heat energy available in the exhaust to a point where even the maximum exhaust gas quantity that can be trapped has insufficient heat after compression to auto-ignite the charge. This is the case for low speed/load operation. Thus it has been found difficult to date to sustain HCCI down to idle; the approach to tackle this problem has typically been to pre-heat the air supply to the engine or to provide a pre-combustion event prior to the main auto-ignition combustion. The purpose of each is to increase the heat energy available for low speed/low load e.g. at engine idle.

The present invention provides the required end of compression temperature for auto-ignition by having a variable compression ratio and by being configured and operated as a two-stroke spark ignition engine, which will always have significant internal EGR (trapped exhaust gas) at all conditions except the highest load. The amount of trapped exhaust gas intrinsically maximizes at the lowest load operation and therefore is very suited to auto-ignition operation. Varying the compression ratio allows optimization of the end of compression temperature to phase the combustion process to maximize the torque and/or minimize fuel consumption/emissions.

The engine described is operated in all conditions using homogenous charge compression ignition (HCCI). The engine is started with HCCI by selecting a compression ratio of 30:1 to 40:1 when the ambient air temperature is above freezing. The engine is started with HCCI by selecting a compression ratio of 50:1 or higher if the ambient air temperature is −30° C. or lower. The engine is operated with a HCCI at idle with a compression ratio of 30:1 to 40:1. In other operating conditions (e.g. part-load and full load), the engine is operated with a compression ratio of between 18:1 and 25:1.

For a start up condition (hot or cold), there will be no exhaust gas available to add to the charge temperature as the engine has to be running to generate the exhaust gas in the first place. In this instance, the compression ratio is raised to its greatest amount so that the engine still starts with ease. Once it is possible to start the engine with HCCI operation, then there is no need for an ignition system and, in particular, no need for a spark plug. This means that the design of the cylinder head can be simplified and the movable puck increased in diameter to match the diameter of the cylinder. This would allow a lower oil pressure requirement to move the puck hydraulically should hydraulic movement be chosen. Engine oil could be used and engine oil can provide cooling of the puck as well as control of position. The two-stroke engine is particularly suited to HCCI starting, since exhaust gas is trapped intrinsically after the first combustion cycle.

The applicant has started a gasoline engine (running with 98RON ULG) without a spark from cool conditions (29 degC coolant and 25 degC conditioned air supply) using a compression ratio 32:1. End of compression temperatures of above 1000° C. have been achieved with a 40:1 compression ratio and ambient temperatures of around 25° C.; this is sufficient to auto ignite natural gas. For the same end of compression temperature when the air temperature is −30 degrees, then a compression ratio of at least 50:1 is needed. E85 fuel requires a slightly higher compression ratio than gasoline, but still within the ranges mentioned. Diesel fuel requires a lower compression ratio than gasoline, but still within the ranges mentioned.

The applicant has run a gasoline engine running unleaded 98RON gasoline with fuel HCCI at speeds of revolution less than 450 rpm with a compression ratio of 36:1.

The applicant has run an engine at 680 rpm idle on E85 fuel in HCCI operation at a compression ratio 37:1.

It is also possible to run an engine with HCCI combustion with diesel fuel using the same low pressure air blast fuel injection, e.g. with a fuel pressure of 6 bar delivering diesel into air at 8.5 bar.

Whilst the two-stroke operation traps exhaust gas at part loads inherently, the trapping valve described above gives greater control over the amount trapped and is therefore a second controlling medium for HCCI operation. Trapped exhaust gas is also needed to slow HCCI combustion to prevent engine damage and excessive NOx emissions. The trapping valve and the variable compression ratio together allow the trapped charge conditions to be optimized to achieve the minimum NOx in auto-ignition.

Whilst a compression ration of 50:1 would work for low temperature start up as described below, as the engine subsequently warms up then the compression ratio will be reduced to e.g. 37:1 at idle to optimize the combustion process. E85 fuel requires a compression ratio 4 or 5 ratios higher at idle speeds.

For 98 ULG fuel then a compression ratio of 37:1 allowed full HCCI operation at a hot idle at 444 rpm. The engine has idled with E85 fuel with full HCCI at a compression ratio of 37:1.

The engine run at very high compression ratios has been found to give minimal NOx emissions—down to background levels at idle, provided that the engine is run with a low BMEP (Break Mean Effective Pressure). The engine in some embodiments is run with a BMEP of 3 to 4 Bar (this compares with 12 Bar for a typical four-stroke engine or 6.5 Bar for a typical known two stroke). Even at higher loads the NOx emissions are low double-digit parts per million up to 2000 rpm, 3 bar IMEP (e.g. approximately 20 ppm at 2.3 bar IMEP). Therefore there is no need for NOx aftertreatments. HC and CO emissions of the 2-stroke engine are comparable to similar 4-stroke engines. The high compression ratio gives rise to significant compression heating which forces the reactions of HC to HCO to CO to CO₂ to completion. It has also been found that use of E85 instead of gasoline gives slightly better NOx output than gasoline and that use of diesel gives slightly higher NOx and HC emissions similar to gasoline.

With the engine of the present invention it may be possible for the engine to dispense with NOx aftertreatments and with fuel consumption better than for a four-stroke spray-guided engine.

The ability to operate HCCI from a cold start can significantly reduce cold start emissions and thus loading of the oxidising catalyst. The engine has been started with 98RON unleaded gasoline at a 25° C. ambient air temperature and a 29° C. coolant temperature using a compression ratio of 32:1, without the need for a spark. Since in some embodiments the engine operates with a low BMEP of 3-4 Bar, to achieve low NOx, the engine will be ‘upsized’ to provide the required total power output while still providing improved fuel economy and reduced powertrain cost, since such an engine with its reduced need for aftertreatments will be cheaper to produce e.g. than a turbo-charged direct injection spark ignition 4-stroke engine (the currently preferred approach). A 3 to 4 litre capacity two stroke engine with a 3-4 Bar BMEP and operating with HCCI and high compression ratios as described above will have a comparable power output to a 1.6 litre capacity four-stroke engine, while providing low NOx throughout its operating range, including at full power (four-stroke engines have high NOx output at full power).

The engine of the current invention will idle in full HCCI operation at speeds of revolution less than 450. This is unheard of before. The engine operated from start with HCCI and so no spark ignition system is needed. The low emission characteristics of the engine are thus available from a cold start. The best efficiencies are seen with higher octane fuels.

The engine according to the present invention, due to its variable compression ratio and trapping valve, can be run on gasoline, E85 or on diesel without any changes of hardware, just a different compression ratio and trapping valve settings. Other fuels and/or mixtures of fuels may also be beneficially employed.

It is possible in a multi-cylinder engine to control the compression ratios separately for each cylinder and to sequentially change the compression ratio of the cylinders in turn.

The present invention provides a ‘cyclic operation Rapid Compression Machine’ (‘RCM’). The variability enables the engine to run with different fuel types, e.g. gasoline, E85 and diesel, easily with no hardware changes. The concept is one of a ‘cyclic-operation RCM’. The concept takes the advantages of the 2-stroke cycle and combines them with other ideas to realise a productionisable VCR engine. VCR is very hard to achieve in a 4-stroke engine and a compression ratio range of 10:1 to 50:1 would effectively be impossible to achieve in such an engine if it is fitted with poppet valves.

Throughout the specification where reference is made to a compression ratio the reference is to the standard geometric compression ratio which refers to ratio of the volume in a cylinder at Bottom Dead Centre (BDC) of the piston to the volume in the cylinder at Top Dead Centre (TDC) of the piston. This ignores any leakage and ignores the fact that the presence of the ports in the cylinder will reduce the effective compression ratio since no compression will occur until the ports are closed.

1. A two-stroke internal combustion engine comprising at least one piston reciprocable within a cylinder,
an exhaust port allowing communication of the cylinder with an exhaust passage, which port is opened and closed by the piston during the reciprocal motion thereof, moveable shutter means for varying an effective area of the exhaust port, which shutter means varies the effective area cyclically in a timed relationship to the reciprocal motion of the piston within the cylinder,
a compression ratio variation mechanism for varying a compression ratio of the cylinder,
sensor means for measuring one or more operating characteristics of the engine and for generating signals corresponding thereto, and
a control unit which processes the signals generated by the sensor means and controls the motion of the shutter means accordingly and controls the compression ratio variation mechanism to vary the compression ratio of the cylinder; wherein the engine has an operating mode at idle in which fuel is ignited in the cylinder by homogeneous charge compression ignition (HCCI) and the compression ratio in the cylinder is varied to fall in the range 30:1 to 40:1.

2. A two-stroke internal combustion engine as claimed in claim 1 wherein the engine has a starting mode in which fuel is ignited on starting of the engine by HCCI and the compression ratio in the cylinder is varied to 40:1 or higher.

3. A two-stroke internal combustion engine as claimed in claim 2 wherein in the starting mode the compression ratio is increased with decreasing ambient air temperatures and the compression ratio is increased to 50:1 or higher when the ambient air temperature is −30° C. or lower.

4. A two-stroke internal combustion engine as claimed in claim 1 wherein the engine has a part-load operating mode in which fuel is ignited by HCCI and the compression ratio in the cylinder is varied to fall in the range 18:1 to 25:1.

5. A two-stroke internal combustion engine as claimed in claim 1 wherein the engine has differing operating modes for different fuels, in each of which operating modes the fuel is ignited by HCCI and the compression ratio in the cylinder is varied by the control unit to suit the fuel used.

6. A two-stroke internal combustion engine as claimed in claim 5, wherein the engine has different operating modes for each of: gasoline; gasoline and ethanol mixes; and diesel.

7. A two-stroke internal combustion engine as claimed in claim 1 which operates with a BMEP of 3 to 4 Bar.

8. A two-stroke internal combustion engine as claimed in any one of the preceding claims 1 in which fuel is always ignited by HCCI on starting of the engine and for all engine speeds and/or loads.

9. A two-stroke internal combustion engine as claimed in claim 1 wherein the control unit at low speeds and/or loads of the engine varies operation of the shutter means to reduce the effective area of the exhaust port during exhausting of combustion gases to trap combusted gases in the cylinder for mixing with subsequently introduced charge air and fuel to create a mixture suitable for homogeneous charge compression ignition.

10. A two-stroke internal combustion engine as claimed in claim 9 wherein the control unit at high speeds and/or loads of the engine varies operation of the shutter means to increase the effective area of the exhaust port during exhausting of combusted gases.

11. A two-stroke internal combustion engine as claimed in claim 1 wherein the compression ratio variation mechanism comprises a junk head of a diameter equivalent to the diameter of the cylinder slidable axially in the cylinder and an actuator for sliding the junk head.

12. A two-stroke internal combustion engine as claimed in claims 1 wherein the shutter means comprises a shutter and a transmission mechanism for oscillating the shutter between a first position in which the exhaust port has a first effective area and a second position in which the exhaust port has a second smaller effective area, the transmission mechanism being connected to a crankshaft connected to the piston of the engine and comprising a plurality of interconnected links.

13. A two-stroke internal combustion engine as claimed in claim 12 wherein the control unit varies the first position of the shutter with change in sensed operating characteristics to advance or retard the opening of the exhaust passage.

14. An internal combustion engine as claimed in claim 1 wherein the control unit controls the shutter means to alter the amount by which the effective area of the exhaust port is varied in each cycle.

15. A method of operating a two-stroke internal combustion engine, the engine comprising:
at least one piston reciprocable within a cylinder;
an exhaust port allowing communication of the cylinder with an exhaust passage, which port is opened and closed by the piston during the reciprocal motion thereof;
moveable shutter means for varying an effective area of the exhaust port, which shutter means varies the effective area cyclically in a timed relationship to the reciprocal motion of the piston within the cylinder;
a compression ratio variation mechanism for varying a compression ratio of the cylinder; and
sensor means for measuring one or more operating characteristics of the engine and for generating signals corresponding thereto; and the method comprises:
controlling the motion of the shutter means to vary in operation of the engine the effective area of the exhaust port available during exhausting of combustion gases;
controlling the compression ratio variation mechanism to vary the compression ratio of the cylinder;
operating the engine at idle with a compression ratio in the cylinder in the range 30:1 to 40:1 and with fuel in the cylinder ignited by homogeneous charge compression ignition (HCCI).

16. A method as claimed in claim 15 comprising additionally starting the engine by igniting fuel in the cylinder by HCCI and operating the engine with compression ratio in the cylinder of at least 40:1.

17. A method as claimed in claim 16 wherein the engine is operated with a compression ratio in the cylinder of at least 40:1 when ambient air temperature is −30° C. or lower.

18. A method as claimed in claim wherein the engine is operated at part-load conditions with fuel ignited in the cylinder by HCCI and with the compression ratio in the cylinder in the range 18:1 to 25:1.

19. A method as claimed in any one of claims 15 to 18 wherein the fuel ignited in the cylinder is one of: gasoline; a mixture of gasoline and ethanol; or diesel.

20. A method as claimed in claims 15 wherein the engine is operated with a BMEP of 3 to 4 Bar and without any NOx aftertreatment of the exhaust gas.

21. A method as claimed in claim 15 wherein fuel in the cylinder is always ignited by HCCI on starting and at all engine speeds and loads.
